(19) United States
(12) Patent Application Publication
(10) Pub. No.: US 2011/0067556 A1
(43) Pub. Date: Mar. 24, 2011

(54) Output selection system for stringed instruments

(76) Inventor: Thomas William Norman, Fremont, CA (US)

(21) Appl. No.: 12/565,803

(22) Filed: Sep. 24, 2009

(51) Int. Cl. G10H 3/18

(52) U.S. Cl. 84/726; 84/731

(57) ABSTRACT

Given a polyphonic pickup system based on either magnets or piezo's with one signal per string of a given multi-stringed musical instrument, switches then transfer the signal from either of a plurality of positions to a plurality of output signals, which can then be processed through different series of effects, making it sound like there are a plurality of instruments using only one.

### FIELD OF THE INVENTION

This device pertains to the field of electronically amplified musical instruments.

### BACKGROUND OF THE INVENTION

The current state of electronics in popular stringed musical instruments, such as the guitar, generally consists of only one output for sending the signal of all strings at once to a speaker. Because of this, any desired sound modification using effects will apply the effect to all strings at once.

To fix this problem there have been many advancements in technology to allow the use of polyphonic pickups that detect the signal of every string and transmit them all to be processed as multiple signals as opposed to one signal, but these devices cannot freely interchange between where the string signal is sent.

One such device is U.S. Pat. No. 4,096,780 to Dawson (1976) which discloses a method of changing how the pickups are coiled initially to create a stereo effect of specially spreading out the volume of every string to make it sound like the strings are far apart, but because the device is so permanent, one cannot change the volumes or location of strings through the speaker at a moment's notice.

### SUMMARY

A multi-stringed musical instrument with strings stretched across two points across the body with tension, with a method of changing the tension to create a desired musical tone when struck. Given a polyphonic pickup device that creates one electrical signal per string provided in said stringed musical instrument either by means of electromagnetism through magnetic coils sensing vibrations from ferromagnetic strings, or by the sensation of pressure creating current through piezoelectric pickups placed under the strings, the electric signal of every string is sent to it's own multi-positional electric toggle switch, whose position decides which pre-amp to send the electrical string signal to, or a potentiometer whose position will decide how much signal goes to one direction, and how much signal goes to another direction. In doing so, one can selectively choose what string signal goes to which output or preamp so as to have different strings going through different speakers. Running these signals through different series of signal effects can give the effect of playing a plurality of instruments at once using only one instrument.

### DRAWINGS

FIG. 1: An electrical diagram depicting the device

FIG. 2: The neck of said multi-stringed musical instrument.

FIG. 3: The body, and preferred embodiment of device.

### DETAILED DESCRIPTION

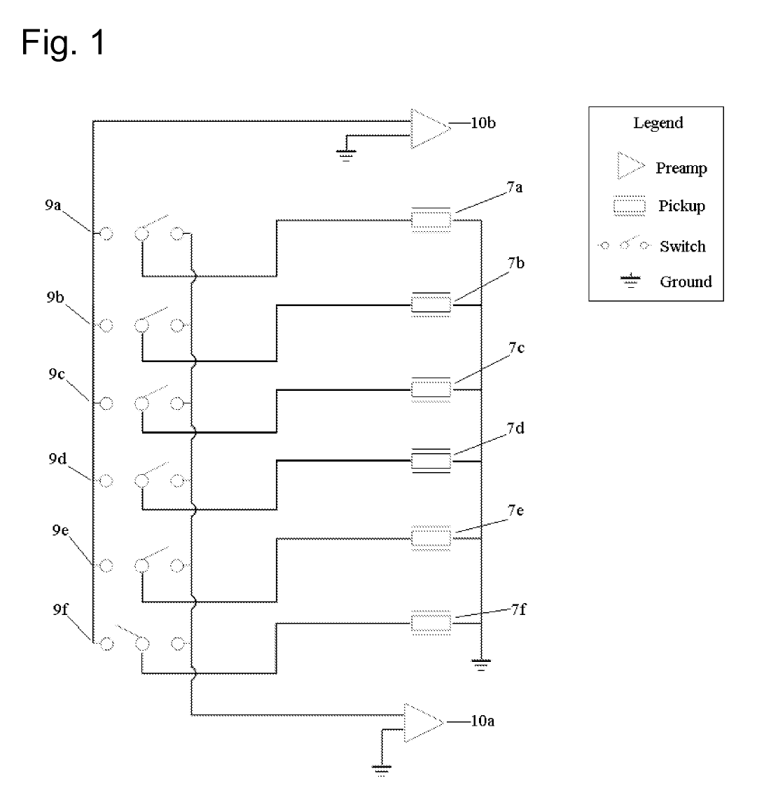

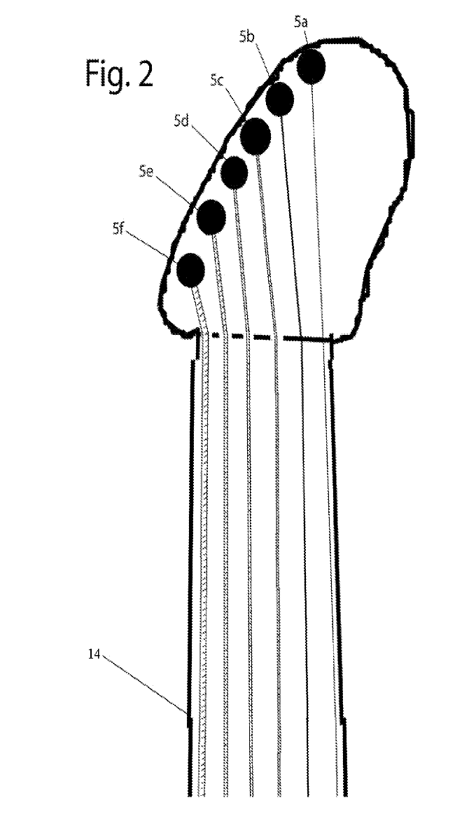

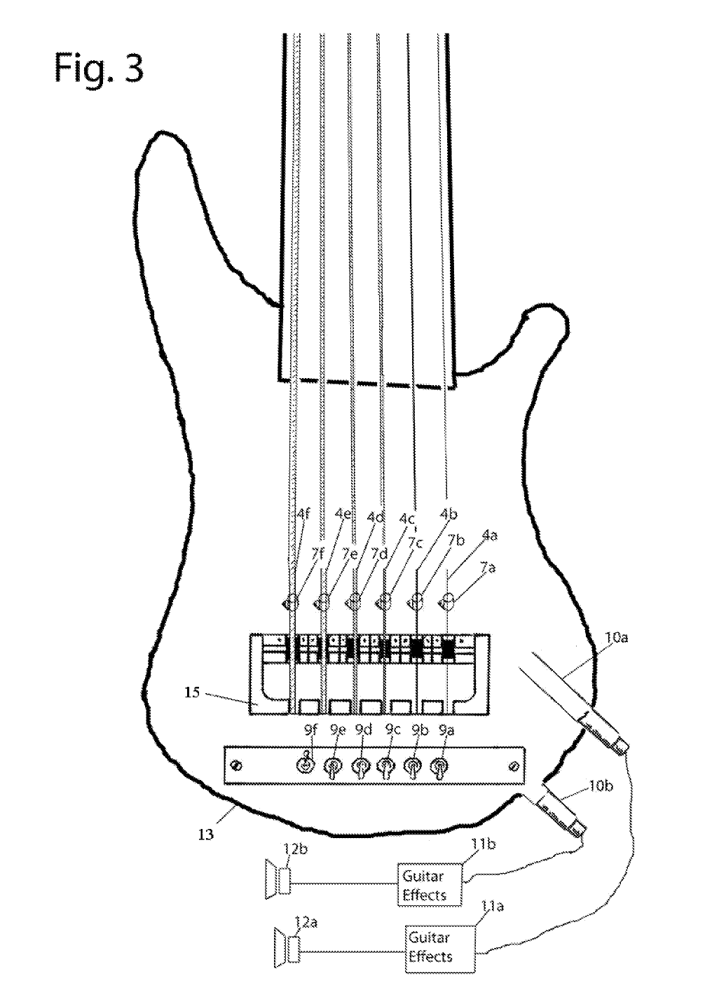

In reference to FIGS. 2, and 3, pictured is a typical electric guitar, constructed by combining a body 13, a neck 14, a bridge 15 to hold the strings 4a-f, which are then stretched across the body and neck and attached to tuning pegs 5a-f on the head 6 with which to tune the strings of the guitar to the desired musical pitch. A polyphonic pickup meant for changing the string vibrations into an electrical signal, pictured in FIGS. 1, and 3. In this illustrative embodiment, pickups 7a-f are magnetic pickups, which detect the vibrations of ferromagnetic strings, and transform the vibrations into an electrical current. In an alternative embodiment, pickups 7a-f are piezoelectric pickups, which detect the vibrations of the strings through the sensation of pressure, with one pickup per string, the signals from every string then going to one electrical switch per string. In this illustrative embodiment, electrical switches 9a-f are multi-positional toggle switches, whose positions equal the number of outputs or preamps 10a-b to send the signals to, which then send the signals to a number of effects chains 11a-b that modify the existing electrical signals, which equals the number of outputs or preamps, which then go to any number of speakers 12a-b. In an alternative embodiment, switches 9a-f are potentiometers, where, in this example, the more a potentiometer is turned toward output or preamp 10a, the higher a percentage of that signal is sent to said output or preamp, while a lesser percentage of said signal is still being sent to output or preamp 10b.

I claim:

1: A polyphonic pickup system for use with a stringed musical instrument comprising of multiple strings taught between two specific points, with means to change the tension of each string to the desired musical pitch, the polyphonic pickup comprising: a plurality of individual pickups, with the number of pickups equaling the number of strings, meant for detecting the vibrations of each string individually and independently of each other to create an electrical signal to be sent onto a system of electrical switches, that can freely change the courses of said electrical signals, to send them to any of a plurality of outputs or preamps.

2: A pickup in accordance with claim 1, for use in a multi-stringed musical instrument using piezoelectric pickups.

3: A pickup in accordance with claim 1, for use in a multi-stringed musical instrument using magnetic pickups.

4: A system of switches in accordance with claim 1, for use in a multi-stringed musical instrument with said electrical signals being sent to a multi-positional toggle switch, whose number equals the number of strings, with one position per output, whose position will decide what output the string signal is sent to.

5: A system of switches in accordance with claim 1, for use in a multi-stringed musical instrument with said electrical signals being sent to a system of potentiometers, whose number equals the number of strings, whose position will decide what percentage of a signal goes to what output.
